(19) United States
(12) Patent Application Publication
(10) Pub. No.: US 2002/0059736 A1
(43) Pub. Date: May 23, 2002

(54) Method and apparatus for precision axial free end play adjustment of tapered bearings

(76) Inventor: Robert Lee Vencill, Williams, OR (US)

Correspondence Address: Oliver D. Olson, Olson & Olson, 2400 S.W. 4th Avenue, Portland, OR, 97201, US

(21) Appl. No.: 10/001,840

(22) Filed: Nov. 21, 2001

Related U.S. Application Data
(60) Provisional application No. 60/252,326, filed on Nov. 22, 2000.

(51) Int. Cl. G01B 5/00

(52) U.S. Cl. 33/832

(57) ABSTRACT

The adjustment of axial free play between the ends of a wheel bearing assembly and a wheel hub and spindle nut of the wheel assembly is achieved by first over-tightening the spindle nut against the wheel hub; secondly, identifying by an indicator gauge between the wheel hub and spindle nut the amount of axial travel of the over-tightened hub on the spindle; thirdly, loosening the spindle nut until an indicator between the hub and spindle nut substantially matches a specified amount of linear travel of the loosened hub; and finally re-tightening the spindle nut by rotating the latter the same axial amount that the hub had traveled after loosening the spindle nut.

This application claims the benefit of Provisional application No. 60/252,326, filed Nov. 22, 2000.

### BACKGROUND OF THE INVENTION

This invention relates to vehicle wheel bearing assemblies, and more particularly to the precise adjustment of axial free end play of the wheel hub and spindle nut at the opposite ends of the tapered bearing assembly.

The magnitude of free end play at opposite ends of a bearing assembly is an important factor which determines the useful operating life of the entire system. No free end play or excessive bearing pre-load, can result in the seizing and destruction of the assembly, while too much end play, or excessive free end play, can result in shortened bearing life, scored or otherwise damaged axle components, total damage to the entire wheel and axle assembly, shortened tire life, and others.

It is usual practice to establish axial free end play by tightening the spindle nut to the point of securing the wheel against any rotation, and then loosening the spindle nut to some random and non-reproducible degree to free the hub for rotation, and then to pull and push the wheel laterally, as with a long pry bar, to note the degree of wobble or end play. Readjustment of the spindle nut may be made to reduce or otherwise refine the degree of wobble, but the end result is a range of adjustments that may be acceptable to the person mounting the wheel, but unacceptable for optimum operation of the assembly.

### SUMMARY OF THE INVENTION

In its basic concept, this invention provides for the precise and reproducible establishment of zero point taper bearing adjustment by utilizing a spindle nut of known thread pitch with corresponding visibly inscribed circumferential indicia for registration with a visible index mark at the adjacent end of the spindle. Additionally, a dial indicator or other suitable linear measuring instrument, is mounted on or otherwise engages the wheel hub and its indicator adjusted to engage the visible end of the spindle. The dial then adjusted to or otherwise made note of zero. With these installations, axial movement of the spindle by a predetermined measure is known precisely, such as by a predetermined rotation of the over-tightened spindle nut noted by the circumferential indicia and index mark, and by the subsequent movement of the index mark back by a magnitude necessary to match the linear movement of the indicator dial or other instrument.

It is the principal objective of this invention to provide a method for the precise and reproducible adjustment of zero end play of a vehicle wheel bearing assembly.

Another important objective of this invention is the provision of apparatus by which to achieve the precise and reproducible adjustment of zero end play of a vehicle wheel bearing assembly.

A further objective of this invention is to provide apparatus of the class described which is of simplified construction for economical manufacture, maintenance and repair.

The foregoing and other objects and advantages of this invention will appear from the following detailed description, taken in connection with the accompanying drawings of a preferred embodiment.

### BRIEF DESCRIPTION OF THE DRAWINGS

FIG. 1 is a fragmentary vertical cross section of a conventional spindle-mounted hub having mounted thereon means for measuring and adjusting the axial free end play of the taper bearings.

FIG. 2 is a front elevation of the spindle nut of FIG. 1 showing the circumferential indicia markings and associated index marker.

### DESCRIPTION OF THE PREFERRED EMBODIMENT

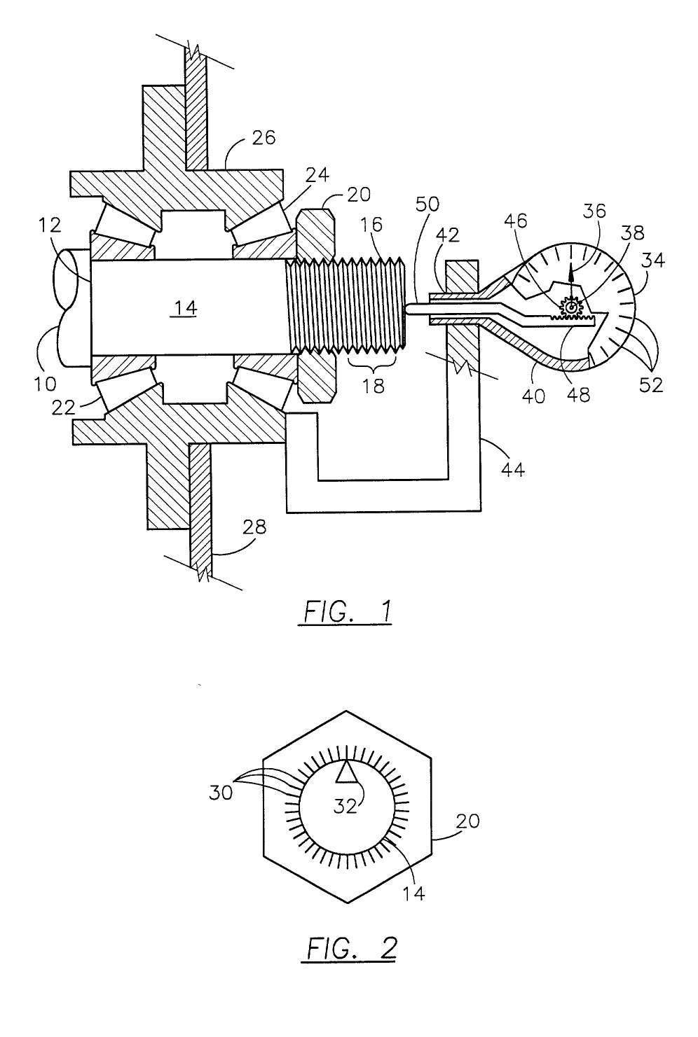

FIG. 1 illustrates a conventional vehicle wheel assembly on a supporting rotary axle 10 that terminates at its outer end in a reduced diameter section, defined by flange 12, that forms a wheel-supporting spindle 14. The outer end portion of the spindle is provided with external threads 16 of a predetermined pitch for establishing the number of revolutions per inch of axial movement 18 of a threaded spindle nut 20 mounted for rotation on the spindle threads.

The spindle 14 is arranged to support inner and outer tapered bearings 22 and 24, respectively, which serve to support the hub 26 of a vehicle wheel 28. The wheel is secured to hub 26 in usual manner, to allow rotation of the wheel.

In accordance with this invention, the zero point determination of axle free end play and precision bearing pre-load adjustment is accomplished by measuring travel of the wheel hub 26 in relation to spindle 14, from a known stressed zero end play position. The bearings first are over-tightened, stressing the hub and spindle assembly such that no free end play exists. Compression and stretch elasticity of all related wheel end components, including spindle 14, hub 26, taper bearings 22 and 24 and the bearing lubricating film, all are known constants. Stress is measured either in foot-pounds of torque or in pounds per square inch of pressure as measured between the communicating faces of spindle nut 20 and the outer bearing 24.

In this regard, it is important to note that the unit measure of torque or pressure is not linear in relation to the travel of hub 26 upon spindle 14. The circumferential indicia 30 (FIG. 2) on spindle nut 20 are spaced apart to closely correlate to the pitch 18 of the spindle screw thread 16 and matching thread of spindle nut 20. Index marker 32 on the visible end of the spindle 14 registers with the indicia 30 to provide for accurate reading.

Indicia 30 measures axial travel of the nut 20, and the axial distance represented by the indicia is twice the axial distance of travel of the wheel hub 26. The axial distance of travel of hub 26 in relation to spindle 14 is measured by noting the number of indicia 30 on nut 20 in relation to index marker 32 on spindle 14.

Additionally, the axial distance of travel of the hub 26 in relation to the spindle 14 is measured by a linear mechanical or electronic instrument. The illustrated mechanical dial indicator 34 is provided with an index marker pin 36 mounted for rotation with shaft 38 secured for rotation on dial indicator housing 40. The housing, in turn, is secured as by welding 42, or other suitable attaching means, to bracket 44. The bracket is secured removably to wheel hub 26, as by screws, magnets, or other conventional means, to afford normal use of the wheel assembly after end play adjustment has been completed.

The index marker shaft 38 is secured for rotation with gear 46 which meshes with a rack 48 on reciprocating plunger 50. The plunger extends slidably through registering openings in housing 40 and bracket 44 and is spring loaded to urge it resiliently against the visible end of spindle 14. Thus, as the linear distance between the hub 26 and spindle 14 changes the index marker pin 36 registers the change in linear dimension relative to the calibrated linear markings 52 on dial indicator 34.

Upon loosening the over-tightened spindle nut 20, the dial indicator 34 measures the axial travel of the wheel hub 26 in relation to the spindle 14. The axial plane of the spindle is positioned horizontally, such that compression and stretch elasticity of the over-tightened assembly, combined with the force of gravity, acts upon the hub 26. As the nut 20 is loosened outwardly, the hub 26 travels axially outward toward the nut 20. This travel is one-half the distance of travel of nut 20, so as to maintain the hub centered in the saddle of the inner and outer tapered roller bearings 22 and 24, respectively.

In similar manner, the axial travel of hub 26, as measured by the calibrated markings 52 on dial indicator 34, is one-half the axial travel of spindle nut 20 and outer bearing 24 as the latter remains in close communication with the nut 20. The unit measure of the indicia 30 on spindle nut 20 correlates to the screw thread pitch 18 which, for example, may be 12 threads per inch, moving the screw 0.083 inch per full revolution. The spacings between indicia markings 30 may be about two times the same unit measure of indicator 34, or nearly 0.001 inch. In this example, the spindle nut 20 would have 42 circumferential markings 30, each representing 0.00198 inch, closely twice the unit of measure of 0.001 inch of indicator 34. Application of specific incremental rotational adjustment of spindle nut 20 precisely and repeatedly sets the bearings 22 and 24 to the desired axial end play and/or bearing pre-load pressure.

A typical adjustment procedure involves rotating the wheel hub 26 while the spindle nut 20 is over-tightened such that the inner and outer tapered roller bearings 22 and 24 are pre-loaded. Spinning the wheel 28 permits the outer races of the bearings to work their way up the inclined planes of the tapered roller bearings. The indicator dial 34 is set to zero, and the spindle nut 20 is slowly loosened in the direction toward free axial end play, decreasing the pre-load of the over-tightened bearings. The wheel is rotated back and forth so as to assist the hub 26 in remaining centered in the bearing saddle without friction-caused axial jumps of travel. It is often experienced that the initial origin of travel is difficult to determine, and experience in this art demonstrates that the hub 26 does not begin to move in relation to spindle 14 until stretch and compression stresses relax as true axial end play approaches zero. This exact point is most difficult to discern, but a full increment of hub travel is easy to identify, such as the 0.001 inch of travel. If the dial indicator 34 immediately indicates travel, the procedure is repeated so as to be assured that adjustment is being initiated pre-stressed.

The full incremental unit of measure, such as 0.001 inch, is the travel of the hub 26, which is one-half the travel of the outer bearing 24 as the hub sits in the saddle of the bearings. The index mark 30 on the spindle 14 (or it may be an edge of a keyway or other mark), and the nut 20 typically is tightened a full indicia increment to provide a precise mechanical means of adjusting taper roller wheel bearings.

To summarize, the procedure involved in this invention begins with the first step of over-tightening the spindle nut 20, the second step of applying a measuring instrument such as dial indicator 34 to measure the axial travel of the hub 26 on the spindle 14; the third step of slowly loosening the spindle nut while rotating the wheel 28 until the measuring instrument 34 registers a desired unit of travel, such as 0.001 inch; and the final step of re-tightening the spindle nut 20 by utilizing the visible indicia 30 on the nut and index mark 34 to tighten the nut two times the measured increment of travel of the dial indicator 34 at the third step. At this point the axial free end play of the taper bearings is substantially zero inches. The nut 20 is secured against further rotation by a cotter pin or any other conventional procedure.

It will be apparent to those skilled in the art that various changes may be made in the size, shape, type, number and arrangement of parts described hereinbefore. For example, the circumferential indicia 30 on the spindle nut 20 may be applied to the visible end of the spindle 14 and the index mark 32 applied to the spindle nut 20 as a reversal of parts. A complete workable, but less precise procedure may be followed by using only one or the other of the indicia marks 30 or dial indicator 36. The type of dial indicator 34 illustrated may be replaced with a wide variety of linear indicators, including calipers. These and other changes may be made, as desired, without departing from the spirit of this invention and the scope of the appended claims.

I claim:

1. A method of adjusting a bearing assembly on a threaded axle spindle between a wheel hub and a threaded spindle nut, comprising:
a) over-tightening the spindle nut against the bearing assembly until there is no linear movement between them,
b) identify the dimensional linear position of the over-tightened wheel hub on the spindle,
c) loosening the over-tightened spindle nut by a selected amount, and
d) re-tightening the spindle nut to the identified dimensional linear position of the wheel hub on the spindle.

2. The method of claim 1 wherein the over-tightening and re-tightening of the spindle nut utilizes circumferentially spaced indicia and an associated index mark one on the spindle nut and the other on the spindle, and the loosening of the over-tightened spindle nut by a selected amount utilizes linear measurement means interengaging the hub and spindle.

3. A system for adjusting a bearing assembly on a threaded axle spindle between a wheel hub and a threaded spindle nut, comprising:
a) circumferentially spaced indicia marks on one of the spindle and spindle nut, graduated to relate to the pitch of threads on the spindle and spindle nut, and index means on the other of the spindle and spindle nut arranged for registry with the indicia marks, and
b) a calibrated linear indicator member and associated contact member one mounted on the wheel hub and the other on the spindle.

4. The system of claim 3 wherein the circumferentially spaced indicia marks are on the spindle nut and the index means is on the spindle, and the calibrated linear indicator member is arranged for engaging on the wheel hub and the associated contact member is arranged for engaging the spindle.

5. The system of claim 4 wherein the calibrated linear indicator means comprises a linear indicator dial having circumferentially spaced apart indicia indicating linear distances, a rotary index marker mounted rotatably on the indicator dial, and index marker actuator means engaging the index marker and arranged for engaging a wheel hub.

6. A system for adjusting a bearing assembly on a threaded axle spindle between a wheel hub and a threaded spindle nut, comprising:
a) circumferentially spaced indicia marks on one of the spindle and spindle nut and graduated to relate to a pitch of threads on the spindle and spindle nut,
b) index means on the other of said spindle and spindle nut arranged for registry with the indicia marks, and
c) linear indicator means interengaging the wheel hub and spindle.
